(19) United States
(12) Patent Application Publication
(10) Pub. No.: US 2012/0032464 A1
(43) Pub. Date: Feb. 9, 2012

(54) MOBILE CONTAINERISED AUTOPSY FACILITY

(75) Inventors: Peng Sun Paul Chui, Singapore (SG); Weng Tim Chong, Singapore (SG); Weng Kai Chong, Singapore (SG)

(73) Assignees: ACRE ENGINEERING PTE LTD., Singapore (SG); HEALTH SCIENCES AUTHORITY, Singapore (SG)

(21) Appl. No.: 13/212,701

(22) Filed: Aug. 18, 2011

Related U.S. Application Data
(63) Continuation of application No. 12/161,107, filed on Jul. 16, 2008, now abandoned.

(51) Int. Cl. A61G 3/00

(52) U.S. Cl. 296/24.38

(57) ABSTRACT

The present invention relates to a containerised autopsy facility with standard hygienic procedures and precautions applied to normal medical operations within a conventional health care centre and the like, hereinafter also known as BSL2, comprises a permanent or semi-permanent structure into which therein is provided all necessary autopsy (instruments/equipment) facilities.

### FIELD OF THE INVENTION

The present invention relates to a containerised autopsy facility and more particularly the present invention relates to a mobile containerised autopsy facility. Most particularly the present invention relates to a specific mobile containerised autopsy facility that includes all necessary features to comply with the requirements set forth by international standards for handling Biohazards Safety Level 2 cases hereinafter would be referred as BSL2 during an autopsy, in particular in remote locations.

### BACKGROUND OF THE INVENTION

A clean facility that maintains clean space without discharging toxic material or pathogenic germs is strongly demanded as the electronic and semiconductor industry and biotechnology have remarkably progressed. For example, the bio-clean room in a biological containment such as P₂ (BSL2) or P₃ (BSL3) is installed in universities, institutes, hospitals and related works, thereby preventing spreading of pathogenic micro-organism, permeable matter, tissue specimen, etc.

Similarly, the same kind of attention is required in an autopsy facility. As anyone skilled in the art would know, an autopsy is a systematic examination of a corpse, especially the human corpse. The process of autopsying a corpse may be an issue of a pathologist and other personnel involved therein as they have been exposed to various infectious agents or bacteria or viruses. Example of infectious agents or bacteria or viruses would include blood borne and aerosolised pathogens such as Human Immunodeficiency Virus (HIV), Hepatitis B and C viruses, Mycobacterium Tuberculosis, Severe Acute Respiratory Syndrome (SARS) and other deadly viruses. Other types of hazards would also include some toxic chemicals such as formalin, cyanide, organophosphates and radiation from radionuclides used for patient therapy and diagnosis. However, such types of hazards may be reduced by proper risk assessment or personal protective equipment, appropriate autopsy procedures and adequate facility design and configuration.

As mentioned earlier, Biohazard Safety Levels have been established by international standards for biomedical and microbiologic laboratories with the same levels and principles now being introduced to autopsy facilities. It was known that any autopsy could be potentially risky to any living being within the facility. These risks could be categorised as BSL2, BSL3 or BSL4, which is caused by classified agents.

The present inventors have applied for a patent registration for the invention relating to BSL3 and BSL4 mobile autopsy facility recently. As mentioned above, the present invention relates to a BSL2 autopsy facility. But still, a brief description of BSL3 and BSL4 would be given herein.

BSL3 is established therein to protect personnel in a facility from health problems arising from being exposed in an environment, which may contain harmful agents, spread by aerosols, of which examples may include Mycobacterium Tuberculosis, Rabies and Y. Pestis. In other words a BSL3 facility is designed for work with indigenous or exotic agents that may cause serious or potentially lethal diseases as a result of exposure or through inhalation.

On the other hand, BSL4 is established for more hazardous situations in which personnel may be exposed to dangerous and exotic agents, and which pose a high risk of aerosol-transmitted exposures to agents causing life-threatening deceases for which, there are no prophylactic or post-exposure treatments.

While BSL2, as in the present invention is established to protect personnel from the majority of blood borne pathogens; BSL2 is associated with standard hygienic procedures and precautions applied to normal medical operations within a conventional health care centre.

Therefore, the background of the invention will now be more directed to the BSL2, as it is the objective of the present invention. It is found that personnel conducting an autopsy in a remote location with primitive conditions are most commonly exposed to infections. In unforseen circumstances, which involve human casualties, it is very important to have a facility capable of accommodating the performance of an autopsy on a human casualty in an environment that complies with the requirements as set forth in BSL2.

Currently, very few nations are equipped with an effective mobile BSL2 autopsy facility. This is because each of the said units is expensive to build and maintain. In the prior art, such facilities are housed in permanent or semi permanent structures and cannot be moved immediately to facilitate containment of outbreaks such as diseases caused by harmful chemical, radiation or organism in remote locations. It is known in the prior art that the only available facility that resembles a mobile autopsy facility is a palletised mortuary.

There are several prior art documents, which describe such mobile facilities. Below is a description of some of the prior art in brief.

U.S. Pat. No. 4,915,435 (hereinafter referred to as U.S. Pat. No. '435), teaches a non-fixed hospital and patient care centres and more particularly relates to a mobile operating room that is fully equipped for invasive surgery. The said document teaches of an invention, which comprises a mobile trailer, which is self contained, an expandable van that includes all of the operating requirements called for in fixed hospital facilities. When the said facility is set up, it is set up on levelling jacks and operating lights and all of the essential facilities for complete invasive surgical procedures including pre and post-op areas in a single van for patients. The disadvantage of this type of arrangement is that medical personnel or patients have to enter directly into the preoperative/recovery area. Micro-organism could be transferred into the main operating compartment in the mobile unit via the clothes of the medical personnel or patients.

U.S. Pat. No. 4,570,733 (hereinafter referred to as U.S. Pat. No. '733), teaches a standard cargo container, which is, reconstructed into a readily transportable hospital unit for providing emergency treatment to injured survivors at a site of a major disaster. U.S. Pat. No. 733 further teaches structural features embodied by the container which contributes to its transportability to the disaster site and subsequently at the site the container has surface transportability as a result of an internal combustion engine operated four wheel drive. One disadvantage of this U.S. Pat. No. '733 is that there are no provisions provided to prevent the spread of microorganisms within the facility.

U.S. Pat. No. 4,425,978 (hereinafter referred to as U.S. Pat. No. '978) teaches a standard cargo container, which is, reconstructed into a readily transportable hospital unit for providing emergency treatment to injured survivors at a site of a major disaster. U.S. Pat. No. '978 further teaches structural features embodied by the container which contributes to its transportability to the disaster site and subsequently at the site the container has surface transportability as a result of an internal combustion engine operated four wheel drive. The general configuration and design of the unit as described in U.S. Pat. No. '978 is similar to and as described in U.S. Pat. No. '733, and therefore the same disadvantage is present hereto which is that there are no provisions provided to prevent the spread of micro-organisms within the facility.

U.S. Pat. No. 6,082,799 (hereinafter referred to as U.S. Pat. No. '799) teaches a mobile ambulatory surgery centre which comprise a motor vehicle in which patients can be scheduled to undergo non-emergency or non-life threatening or elective surgical procedures. U.S. Pat. No. '799 further teaches that the main body section is designated and separated into sterile and non-sterile areas. However, this patent does not teach provision to prevent the spread of microorganism within the facility.

U.S. Pat. No. 5,964,065 (hereinafter referred to as U.S. Pat. No. '065) teaches a modular transportable field emergency medical facility. According to U.S. Pat. No. '065, an air filtration or conditioning system and passageway airlocks maintain a positive pressure in the operating or post operative compartments for preventing any type of contamination. This patent further includes a deployed system layout that provides efficient patient movement and avoids cross-contamination. However, the disadvantage of this facility is that it does not operate under a negative pressure system.

U.S. Pat. No. 5,711,916 (hereinafter referred to as U.S. Pat. No. '916) teaches a mobile analytical laboratory that is air transportable as a commercial airfreight unit. The said laboratory further includes an analytical module, a power module and a service module in which when said components are interconnected, forms an independent functioning laboratory which is capable of performing sophisticated chemical analyses. Each module includes a base upon which components are mounted thereto and a removable protective cover is provided and adapted to serve as a module support when inverted. In short, U.S. Pat. No. '916 teaches a self-contained, transportable laboratory for the detection and quantification of contamination in gaseous and liquid samples.

U.S. Pat. No. 5,775,758 (hereinafter referred to as U.S. Pat. No. '758) teaches a portable emergency care facility having an elongated enclosure having first and second ends and two opposing long walls extending between the first and second ends. There is a plurality of wheels on the enclosure to facilitate transportation of the facility. Inside the enclosure is a plurality of treatment tables extending from one of the long walls towards the center of the enclosure, each of the treatment tables being sufficiently spaced from the others to allow patient access on both sides of the treatment tables. In other words, U.S. Pat. No. '758 teaches a portable self-contained, self-sufficient facility for the delivery of emergency care, readily transportable on ground or air for a plurality of patients.

U.S. Pat. No. 6,179,358 (hereinafter referred to as U.S. Pat. No. '358) teaches a mobile hospital system which can be moved by tractors, helicopters, railway locomotive and/or sea vessels and provide comprehensive diagnoses and medical treatments to casualties and patients. A plurality of container wagons functionally operate as part of a hospital and are moved appropriately to set up a comprehensive hospital system by connecting the plurality of container wagons on site. Some of the container wagons are supplied with water, power and fuel from a water supply wagon, a power generating wagon and an oil supply wagon, respectively.

U.S. Pat. No. 4,743,059 (hereinafter referred to as U.S. Pat. No. '059) teaches a mobile sanitary unit, which can function autonomously at any site. The unit comprises a sealed aseptic container with the dimension of a standard 20-foot container. The said container includes a door, which gives access to an operating theatre, changing facility and storage area. The unit further includes other features such as electrical supply and other conventional components. The said unit may also be transported by air and its weight enables it to be dropped by parachute.

U.S. Pat. No. 4,850,268 (hereinafter referred to as U.S. Pat. No. '268) teaches a multi purpose room for mobile applications. The room comprises a housing structure having an airtight laboratory unit and an entrance unit, an air conditioning and exhausting equipment unit to be installed in the upper part of the housing structure and a drain processing equipment unit to be equipped in the airtight laboratory unit.

French Patent No. 2819536 (hereinafter referred to as FR '536) teaches a modular laboratory with P2, P2+ or P3 levels of confinement, namely for the detection of pathogenic agents.

Any discussion of documents, devices, acts or knowledge in this specification is included to explain the context of the invention. It should not be taken as an admission that any of the material forms a part of the prior art base or the common general knowledge in the relevant art in Singapore or elsewhere on or before the priority date of the disclosure and claims herein. All statements as to the date or representation as to the contents of these documents is based on the information available to the applicant and does not constitute any admission as to the correctness of the dates or contents of these documents.

Therefore, it is an objective of the present invention to overcome all the above-mentioned disadvantages by providing a fully containerised mobile autopsy facility, which is capable of being transported to a remote location in order to provide autopsy facilities that would at least comply to the said BSL2 requirements.

It is a further objective of the present invention to provide an autopsy facility that is an elongated enclosure in which said enclosure further includes all necessary equipment of components and space to comply with BSL2 requirements, for use in remote contamination zones.

It is a further objective of the present invention to be apparent from the following description of its advantages and objectives, taken in connection with the accompanying drawings, by way of illustrations and examples, an embodiment of the present invention is disclosed herein.

### SUMMARY OF THE INVENTION

The present invention relates to a containerised autopsy facility with standard hygienic procedures and precautions applied to normal medical operations within a conventional health care centre and the like, hereinafter also known as BSL2, comprises a permanent or semi-permanent structure into which therein is provided all necessary autopsy facilities. The said containerised autopsy facility is a mobile containerised autopsy facility. The said mobile autopsy facility comprises a plurality of compartments such as a filtering room, an autopsy room, an anteroom, a decontamination shower room, a first changing room, a second changing room, a shower room and a passageway.

All the above-mentioned compartments are interconnected to one another. A plurality of access doors is provided therein to connect each of the said compartments in a safe manner. According to the present invention each of the compartments are provided therein with the necessary autopsy equipment and wherein the said mobile autopsy facility is further provided with another separate compartment which is an air conditioning facility, and wherein the said air conditioning facility would be transported together with the autopsy facility and wherein the said autopsy facility can be either transported by land, air, sea or by any other means. The mobile autopsy facility is preferably an insulated or a refrigerated compartment, which is seamed and sealed before any mechanical, electrical, or safety equipment is installed therein.

Further to this, the mobile autopsy facility is preferably constructed with an outer frame-like member, which is insulated, and an inner lining means to form an inner frame-like member.

The mobile autopsy facility further comprises a ventilated workstation, a sink member, a trolley, a fresh air conditioning system and a filtering exhaust air system. The internal surface of the mobile autopsy facility is preferably made of stainless steel material and the upper inner surface of the said mobile autopsy facility is reinforced with stainless steel plates.

As mentioned earlier, the filtering room encapsulates a filtering means, which is selected from conventional filtering means such as a pre/rough filtering means, high efficiency particulate air (HEPA) filtering means and also gas-phase filtering means. The gas-phase filtering means is provided therein as an odour control member in the filtering room during operation. The earlier mentioned workstation, sink member and trolley are equipment provided in the autopsy room. A plurality of air ducts is provided at the workstation and wherein the said air ducts are to connect the filtering room to the workstation.

The anteroom according to the present invention is provided, configured and designed to create an enclosed surrounding between the autopsy room and the autopsy facility entrance. The decontamination shower room is provided therein as a cleaning area for personnel on duty to clean himself or his suit before exiting the autopsy facility. The changing rooms are provided therein to allow the personnel on duty to change his attire and to place his decontaminated suit in a waste bin.

The mobile autopsy facility further includes a plurality of gauge meters to measure the pressure in the compartments in the said autopsy facility to ensure that the pressure therein is always in a negative value. The mobile autopsy facility could further be provided with telecommunication facilities such as telephones, CCTV and the like.

A method of conducting an autopsy in a mobile autopsy facility comprises the steps of:—
(i) preparing all necessary equipment for conducting an autopsy in the autopsy room,
(ii) sealing a corpse which is to be autopsied in a double bag packaging before placing the same on a body tray on the trolley,
(iii) moving the trolley with the corpse thereto into the anteroom by autopsy attendants (who are attired in the proper PPE),
(iv) parking the trolley (with the corpse in the tray) adjacent to the workstation in the autopsy room, by the autopsy attendants who will thereafter exit the facility via the anteroom,
(v) the Autopsy personnel (the pathologist and his assistant) on duty will then be entering the autopsy facility dressed in their proper attire,
(vi) performing of the autopsy by the Autopsy personnel,
(vii) resealing the corpse in the body bag after the autopsy is completed and thereafter decontaminating the sealed body bag together with all equipment used therein in the autopsy room by the Autopsy personnel,
(viii) wheeling the decontaminated bag with the corpse (sealed in) on the tray on the trolley out to the anteroom by the Autopsy personnel,
(ix) wheeling the trolley with the corpse on the tray in a sealed bag out of the autopsy facility by autopsy attendants,
(x) decontaminating the autopsy room by autopsy personnel followed by their self decontamination
(xi) finally exiting the autopsy facility by autopsy personnel on duty after showering and changing their clothes in the changing room,
(xii) the above-mentioned steps are repeated for each autopsy operation.

Other aspects and preferred aspects are disclosed in the specification and/or defined in the appended claims, forming a part of the description of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

Further disclosure, objects, advantages and aspects of the present application may be better understood by those skilled in the relevant art by reference to the following description of preferred embodiments taken in conjunction with the accompanying drawing, which are given by way of illustration only, and thus are not limitative of the present invention, and in which:

FIG. 1 shows a plan view of the present invention, which includes a containerised autopsy facility.

### DETAILED DESCRIPTION OF THE INVENTION

Now the present invention will be described in detail with reference made to the accompanied drawings but not limited to the same thereof.

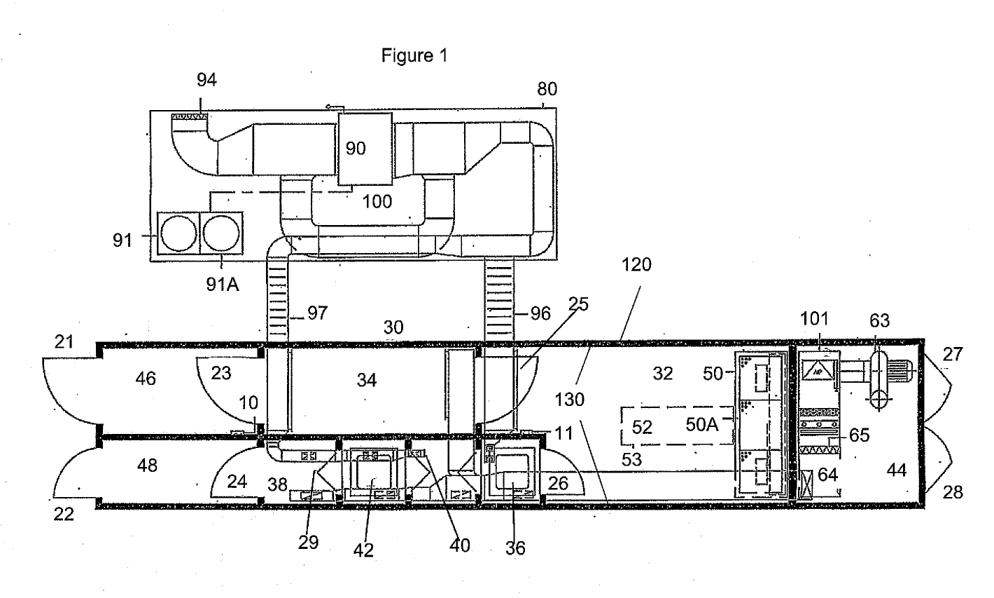

Making reference to FIG. 1 in which there is shown a containerised autopsy facility 30 according to the present invention. The said autopsy facility 30 is an insulated container or a refrigerated container. With this configuration, the autopsy facility 30 is deemed as a mobile independent compartment. The design and configuration of the said autopsy facility 30 may vary according to needs and requirements without departing from the spirit of the invention. One example of the type of containers which may be used according to the present invention would be a container with preferably a dimension of 20 ft×8 ft (also known as 20 Foot ISO containers), 40 ft×8 ft (also known as 40 Foot ISO containers), super high cube containers (also known as oversized containers) and air containers (containers conforming to the standards laid down for use in air transportation). For the purpose of describing the present invention, it would be preferred that the 40 Foot ISO containers be selected for the autopsy facility 30.

It is very important to ensure that the autopsy facility 30 is seamed and sealed before any mechanical, electrical or safety devices are installed therein. All services entering and exiting the autopsy facility 30 are sealed. This configuration has the feature of a “box-in-box” concept. A “box-in-box” concept is when an insulated container forms an outer box, while another inner lining forms an inner box. Such an arrangement will therefore provide a double seal for the said autopsy facility 30.

The autopsy facility 30 according to the present invention comprises a filter room 44, an autopsy room 32, an anteroom 34, a decontamination shower 36, a first changing room 38, a second changing room 40, a shower room 42 and a passage way 48.

The autopsy facility 30 would be preferably configured to comply with BSL 2-3 level by providing a controlled means for entry and exit; a ventilated downdraft workstation 50 with a sink 50A and a mobile autopsy trolley 52; fresh air conditioning and a negative pressure filtering exhaust air system. The autopsy room 32 would be preferably configured to provide between 15-20 Air Changes an hour within the autopsy room 32. Also provided in the autopsy facility 30 would preferably be a separate compartment for an air filtration system 101 and an exhaust fan 63.

As mentioned earlier, the autopsy facility 30 should be housed in an insulated or refrigerated container. The internal surface of the container should preferably be made of stainless steel materials. Outfitting works shall be done to the said container in order to convert the internal surface of the container into a sealed compartment. In addition to that, a secondary layer of stainless steel is further provided therein to cover the internal upper surface of the container. The said secondary layer is provided therein after the installation of all necessary mechanical, electrical and safety services. The floor of the said container should be of stainless steel finishing. All the floor, wall and ceiling shall then cooperatively form a seamless compartment.

The filter room 44 according to the present invention encapsulates within it a HEPA filter means 64. The said HEPA filter means 64 is part of the earlier mentioned exhaust system. According to the preferred embodiment of the present invention, the said HEPA filter media 65 is preferably configured and designed to have an efficiency of 99.97% of filtering at 0.3 microns, an ultra-violet ray sector and a pre-activated carbon sector for controlling the level of odour in the said filter room 44.

Container doors 27, 28 are always closed during all autopsy and general laboratory work. Each door is opened only to access the filter room 44 for maintenance of equipment and instruments as necessary.

The autopsy room 32 according to the preferred embodiment of the present invention comprises a ventilated downdraft workstation 50. The said workstation 50 further includes a sink member 50A and a mobile autopsy trolley 52. Further to this, the said workstation 50 is provided with a plurality of air ducts (not shown). The said air ducts are specially designed and provided therein to connect the filter room 44 to the exhaust air duct of the workstation. It would be appreciated that at least 15-20 air changes per hour is achieved within the autopsy room 32 and the said air is always at a negative pressure. A door 25 which fronts the entrance of the autopsy room 32 is preferably made of steel material. This particularly is provided therein to control the entrance and exit pattern of the entire compartment. Further to this, an intercommunication system (not shown) is also provided therein and the said intercommunication system is thereafter connected to a central command centre, which is to be provided on site.

The anteroom 34 is provided and designed therein to create an airlock between the autopsy room 32 and the entrance to the autopsy facility 30. The said anteroom 34 is also provided to accommodate the movement of the mobile autopsy trolley 52 within the autopsy room 32. Further to this, the said anteroom 34 is also equipped with gauges 10, 11 to measure and ensure that the pressure in the said anteroom 34 is always held at a negative value. The said gauges 10, 11 are Magnahelic Gauges which are readily available in the market.

The decontamination shower 36 is positioned at the exit point of the autopsy room 32. The said decontamination shower 36 is provided therein so that after each autopsy, the pathologist and his assistant (the autopsy personnel) could clean themselves or decontaminate their personal protection equipment (PPE) before leaving the autopsy facility 30. An entrance door 24 and an exit 26 door to the said decontamination shower 36 are interlocked with one another to ensure that a negative pressure is always preserved therein.

The changing room 40 is provided therein to facilitate the pathologist and his assistant to change their decontaminated suits and to place the said suits into a waste bin (not illustrated). It would be appreciated that the shower room 42 shall be accessible from the decontamination shower 36. It would also be appreciated that the shower room 42 should be provided with cold and hot shower means and it should also be provided with standard toiletries and accessories. It would also be appreciated that the changing room 38 be located after the shower room 42. A door 29 leading from the shower room 42 to the changing room 38 is designed to be a one-way access door and it should open outwardly towards the changing room 42. The said door is preferably interlocked with the entrance to the decontamination shower 36.

An air conditioning system 100 is also provided for the autopsy facility 30 and the said air conditioning system is housed in an open container 80. The said container 80 would be transported together with the autopsy facility 30 when the autopsy facility 30 is to be used. Flexible ducts 96 and 97 are installed therein and are used to connect the conditioned supply air from the air conditioner 90 in the container 80 to the supply air ducts in autopsy facility 30. The said ducts 96 and 97 are designed and configured such as to cater for at least 15-20 air changes per hour within the autopsy room 32 and the anteroom 34. Fresh Air is drawn from the atmosphere via a fresh air intake grille 94 through a series of pre and roughing filters before being supplied to a specially selected air-cooled split type pre-cooled air-conditioner 90 for conditioning and cooling of the air before it is being supplied to the conditioned space. A plurality of condensing units 91 and 91A shall be provided and interconnected to a fan coil unit of the air-cooled split type air conditioner 90 by a plurality of refrigerant pipes. All the earlier mentioned components are located in the container 80 and are secured therein by fastening bolts.

The exhaust air from the autopsy facility 30 should preferably pass through a filter system 64 drawn out by an exhaust fan 63. The air conditioning system shall also be designed in such a manner that the air-conditioner will only operate when the exhaust system is operating. This is to ensure and prevent the possibility of creating a positive pressure in the autopsy room 32. The air-conditioned space shall be maintained in a negative pressure and pressure gauges 10 and 11 shall be installed within these rooms to monitor the said pressure.

The exhaust air after being filtered by the HEPA filter media 65 shall be discharged to the atmosphere via a PVC pipe (not shown). The pipe shall stand at a height of 3.0 meters from the top of the autopsy facility 30. It would be appreciated that wastewater from the downdraft workstation 50 with a sink 50A and floor traps of the autopsy facility 30 should be collected at a common point and discharged to a dilution tank (not shown) before being discharged to the sewer system.

Now the working mechanism of the present invention and other features not described earlier will be described in detail. An autopsy attendant will prepare all instruments/equipment necessary for the autopsy in the autopsy room 32 before each autopsy. The corpse to be autopsied will be sealed in double body bags before being placed on a body tray 53. The corpse in the double body bags on body tray 53 on the mobile autopsy trolley 52 will then be wheeled into the anteroom 34 via a security door 21, the entrance of the autopsy facility 30. Some of the equipment/instruments that are required for the autopsy could be placed on a perforated shelf at the lower portion of the mobile autopsy trolley 52. An anteroom door 23 is provided at the opening to the anteroom 34 and is interlocked with the autopsy room door 25 to the autopsy room 32. It would be understood that the anteroom door 23 would have to be closed before the autopsy room door 25 can be opened. This is to maintain the negative pressure as well as act as an airlock between the autopsy room 32, the anteroom 34 and the surrounding area of the autopsy facility 30. The earlier mentioned differential gauges 10 and 11 are positioned at the entrance to the anteroom 34 and at the entrance of the autopsy room 32 respectively. These gauges 10, 11 will indicate the pressure of the rooms at any given time. Operators must ensure that both the anteroom 34 and the autopsy room 32 are at a negative pressure to the atmosphere.

The autopsy attendants will then position the mobile autopsy trolley 52 (on which the corpse, which is sealed in the double body bags has been placed on the autopsy tray 53) adjacent to the workstation 50. The autopsy tray 53 will overlap the sink 50A in the workstation 50 when properly positioned. This allows all running water/body fluid collected in the autopsy tray 53 to flow directly into the sink 50A and then to the drain/waste dilution system.

The pathologist and his assistant who are now dressed in scrubs will enter the autopsy facility 30 via a security door 22 then through the changing room door 24 in order to enter the changing room 38. There they would put on a Class 2/3 PPE suits before entering the autopsy room 32 via the decontamination shower room door 26.

When an autopsy is completed, the corpse will be resealed in double body bags. The sealed body bags in which the corpse is enclosed will then be decontaminated in the autopsy room 32 by manual disinfectant spraying (not shown). The instruments/equipment used in the autopsy will be decontaminated in the same manner. The corpse in double body bags on the autopsy tray 53, which is on the mobile autopsy trolley 52, will then be wheeled out to the anteroom 34 via the autopsy room door by the pathologist's assistant. He will then re-enter the autopsy room 32 and at the same time close the autopsy room door behind him. The autopsy attendants will then enter the anteroom 34 via the security door 21 and the anteroom door 23. They will wheel the mobile autopsy trolley 52 with the corpse enclosed in the double bags on the autopsy tray 53 out of the anteroom 34 via anteroom door 23 and through a passageway 46. They will exit the autopsy facility 30 via security door 21. The pathologist and his assistant will now decontaminate the autopsy room 32 by manual spraying with decontaminant (not shown).

After the decontamination of the autopsy room 32, the pathologist and his assistant will decontaminate themselves by spraying each other with decontaminant manually. The pathologist will enter the decontamination shower 36 via the decontamination shower door 26 to clean his PPE. He will then remove his BSL 2/3 PPE in the changing room 40 and shower off in the shower room 42. He will then change into fresh “scrubs” in the changing room 38 and then exit the autopsy facility 30 via passageway 48 through the changing room door 24 and the security door 22.

The autopsy attendants will then be able to access the autopsy facility 30 for cleaning purposes. Waste must be disposed in proper biohazard bags. All drain/waste water will be drained to a dilution tank (not shown) before being discharged to the sewer. The above-mentioned procedures are repeated when an autopsy is to be carried out and when an autopsy is completed.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.”

1-19. (canceled)

20. A containerised autopsy facility with standard hygienic procedures and precautions applied to normal medical operations within a conventional health care centre, hereinafter also known as BSL2, comprises a permanent or semi-permanent structure into which therein is provided all necessary autopsy facilities characterized in that said containerised autopsy facility is a mobile containerised autopsy facility (30) and wherein the said mobile autopsy facility (30) comprises a plurality of compartments including a filtering room (44), an autopsy room (32), an anteroom (34), a decontamination shower room (36), a first changing room (38), a second changing room (40), a shower room (42) and a passageway (48), wherein the anteroom (34) is provided, configured and designed to create an airlock between the autopsy room (32) and the entrance of the autopsy facility (30), and wherein all the above mentioned compartments are interconnected to one another in an enclosed manner, and wherein a plurality of access doors are provided therein to separate each of the said compartments in a safe manner, and wherein each of the compartments are provided therein with the necessary autopsy equipment and wherein the said mobile autopsy facility (30) is further provided with another separate compartment which is an air conditioning facility (100), and wherein the said air conditioning facility would be transported together with the autopsy facility (30) and wherein the said autopsy facility (30) can be either transported by land, air, sea or by any other means.

21. A containerised autopsy facility as claimed in claim 1 wherein the mobile autopsy facility (30) is an insulated or a refrigerated compartment.

22. A containerised autopsy facility as claimed in claim 1 wherein the mobile autopsy facility (30) is seamed and sealed before any mechanical, electrical or safety equipment are installed therein.

23. A containerised autopsy facility as claimed in claim 1 wherein the mobile autopsy facility (30) is constructed with an outer frame like member (120), which is insulated, and an inner lining (130) to form an inner frame like member.

24. A containerised autopsy facility as claimed in claim 1 wherein the mobile autopsy facility (30) further comprises a ventilated workstation (50), a sink (50A), a trolley (52), and a fresh air conditioning system.

25. A containerised autopsy facility as claimed in claim 1 wherein the filtering room (44) houses a filtering means (64), which is selected from conventional filtering means including a HEPA filtering means.

26. A containerised autopsy facility as claimed in claim 6 wherein the filtering means (64) is provided therein as an odour control member in the filtering room (44) during operation.

27. A containerised autopsy facility as claimed in claim 5 wherein the workstation (50), sink (50A) and trolley (52) are equipment provided in the autopsy room (32).

28. A containerised autopsy facility as claimed in claim 5 wherein a plurality of air ducts are installed at the workstation and wherein said air ducts are to connect the filtering room (46) to the workstation (50).

29. A containerised autopsy facility as claimed in claim 1 wherein the decontamination shower room (36) is provided therein as a cleaning area for the personnel on duty to clean himself and his PPE before exiting the autopsy facility (30).

30. A containerised autopsy facility as claimed in claim 1 wherein the changing rooms (38, 40) are provided therein to allow personnel on duty to change their attire and to place their decontaminated suits in a waste bin.

31. A containerised autopsy facility as claimed in claim 1 wherein the mobile autopsy facility (30) further includes a plurality of gauge meters to measure the pressure in the compartments in the said autopsy facility (30) to ensure that the pressure therein is always in a negative value.

32. A containerised autopsy facility as claimed in claim 1 wherein the mobile autopsy facility (30) further includes telecommunication facilities.
